(19) United States
(12) Patent Application Publication
(10) Pub. No.: US 2022/0013251 A1
(43) Pub. Date: Jan. 13, 2022

(54) CABLE AND MANUFACTURING METHOD THEREOF

(71) Applicant: James Cheng Lee, La Habra, CA (US)

(72) Inventor: James Cheng Lee, La Habra, CA (US)

(21) Appl. No.: 17/239,853

(22) Filed: Apr. 26, 2021

Related U.S. Application Data
(60) Provisional application No. 63/048,693, filed on Jul. 7, 2020.

(30) Foreign Application Priority Data
Feb. 9, 2021 (CN) 202110175504.7

(51) Int. Cl. H01B 7/02; H01B 3/44; H01B 13/10

(52) U.S. Cl. CPC H01B 7/0216; H01B 3/44; H01B 13/10; H01B 7/0258; H01B 7/025

(57) ABSTRACT

Provided is a method of manufacturing a cable, including the following steps of: (a) providing two lateral sides of an inner layer that enclose two sides of a first conductor along a circumferential direction and an opposite direction of the circumferential direction respectively and join to each other, such that the inner layer covers an outer surface of the first conductor; and (b) providing an outer layer that continuously wraps around an outer surface of the inner layer along the circumferential direction and a length direction of the first conductor, thereby forming the cable. Provided is also a cable manufactured by the above method.

### CROSS-REFERENCE TO RELATED APPLICATIONS

This application claims the benefit of the U.S. Provisional Patent application No. 63/048,693, filed on Jul. 7, 2020, and CN Patent application No. 202110175504.7, filed on Feb. 9, 2021, which are hereby incorporated by reference as if fully set forth herein.

### BACKGROUND OF THE INVENTION

### 1. Field of the Invention

The present invention relates to a cable and a manufacturing method thereof, and particularly to a cable having excellent electrical characteristics and mechanical properties, and a method of manufacturing the same.

### 2. The Prior Arts

Generally, a cable includes a conductor and an insulating layer, the insulating layer covers an outer surface of the conductor, the insulating layer may protect the conductor and provide insulating effect.

There are two kinds of conventional manufacturing method for a cable, including extrusion molding method and winding method. As shown in FIG. 1, in the extrusion molding method, an insulating material undergoes extrusion molding on an outer surface of a conductor 2, the insulating material forms an insulating layer 3, in order to produce a cable 1. As shown in FIG. 16, in the winding method, an insulating wrapping layer wraps around an outer surface of a conductor, the insulating wrapping layer forms an insulating layer, in order to produce a cable.

To lower the Insertion Loss (dB) in the application of enhancing the transmitting efficiency of a high-speed cable, insulating materials with lower dielectric constants are normally required for an insulating layer, such as polypropylene (PP), polyethylene (PE), perfluoroalkoxy (PFA), fluorinated ethylene propylene (PFA), and polytetrafluoroethene (PTFE). The insulating materials that are commonly used for the extrusion method include polypropylene, polyethylene, fluorinated ethylene propylene and perfluoroalkoxy. The insulating materials that are commonly used for the winding method include polytetrafluoroethene.

However, there are issues in the extrusion molding method: the dielectric constant of the insulating layer has a profound influence on high-frequency/high-speed transmission performance, such that foam materials are usually used for lowering the dielectric constants. However, it is difficult to achieve standard distributions and yield rates of the foam materials during the manufacturing process.

Although the winding method may solve the issues in the extrusion molding method, it is difficult for winding machine to control the tension of the insulating wrapping layer on the conductor since the insulating wrapping layer being made of polytetrafluoroethene is softer. If the insulating wrapping layers are overly tightened on the winding machine, the encapsulation of the insulating wrapping layers would not be ideal for sealing, and poor adhesion with the conductor may cause the sliding between the insulating wrapping layer and the conductor. Apparent deformation of the insulating layer that causes puckering and poor roundness, eccentricity of the conductor and poor concentricity of a cable are shown in FIG. 17. The aforementioned issues may deteriorate the electrical characteristics and the mechanical properties of the cable.

### SUMMARY OF THE INVENTION

An objective of the present invention is to provide a cable that prevents puckering of an inner layer, such that the inner layer may be evenly covered on an outer surface of a first conductor, so as to enhance adhesion and encapsulation between the inner layer and the first conductor, and a manufacturing method thereof.

Another objective of the present invention is to provide a cable that enhances an overall structural strength of the cable, to prevent issues such as deformation of the inner layer and an outer layer and eccentricity of the first conductor at the same time, such that roundness and concentricity and of the cable may be enhanced, and a manufacturing method thereof.

A further objective of the present invention is to provide a cable that has better electrical characteristics and mechanical properties compared to that of a cable that is made by a conventional winding method, and a manufacturing method thereof.

To achieve the above objective, according to a first aspect of the present invention, there is provided a method of manufacturing a cable, which includes the following steps of: (a) providing two lateral sides of an inner layer that enclose two sides of a first conductor along a circumferential direction and an opposite direction of the circumferential direction respectively and join to each other, such that the inner layer covers an outer surface of the first conductor; and (b) providing an outer layer that continuously wraps around an outer surface of the inner layer along the circumferential direction and a length direction of the first conductor, thereby forming the cable.

In one embodiment, the inner layer includes a first wrapping layer, two lateral sides of the first wrapping layer enclose two sides of the first conductor along the circumferential direction and the opposite direction of the circumferential direction respectively and join to each other, such that the first wrapping layer covers the outer surface of the first conductor.

In one embodiment, wherein the inner layer includes a plurality of the first wrapping layers, two lateral sides of the plurality of the first wrapping layers enclose the two sides of the first conductor along the circumferential direction and the opposite direction of the circumferential direction respectively in sequence and join to each other, such that one of the plurality of the first wrapping layers covers the outer surface of the first conductor, and the rest of the plurality of the first wrapping layers sequentially cover an outer surface of a former layer of the plurality of the first wrapping layers.

Preferably, the first wrapping layer includes an insulation material.

Preferably, the insulation material includes polytetrafluoroethene.

In one embodiment, the outer layer includes a second wrapping layer, the second wrapping layer continuously wraps around the outer surface of the inner layer along the circumferential direction and the length direction of the first conductor.

In one embodiment, the outer layer includes a plurality of the second wrapping layers, one of the plurality of the second wrapping layers continuously wraps around the outer surface of the inner layer along the circumferential direction and the length direction of the first conductor, and the rest of the plurality of the second wrapping layers continuously wrap around an outer surface of a former layer of the plurality of the second wrapping layers along the circumferential direction and the length direction of the first conductor.

Preferably, the second wrapping layer includes an insulation material.

Preferably, the insulation material includes polytetrafluoroethene.

To achieve the above objective, a cable according to a second aspect of the present invention comprises: a first conductor; an inner layer, wherein two lateral sides of the inner layer enclose two sides of the first conductor along the circumferential direction and the opposite direction of the circumferential direction respectively and join to each other, such that the inner layer covers an outer layer of the first conductor; and an outer layer continuously wrapping around an outer surface of the inner layer along the circumferential direction and a length direction of the first conductor.

In one embodiment, the inner layer includes a first wrapping layer, two lateral sides of the first wrapping layer enclose two sides of a first conductor along a circumferential direction and an opposite direction of the circumferential direction respectively and join to each other, such that the first wrapping layer covers the outer surface of the first conductor.

In one embodiment, the inner layer includes a plurality of the first wrapping layer, two lateral sides of the plurality of the first wrapping layers enclose the two sides of the first conductor along the circumferential direction and the opposite direction of the circumferential direction respectively in sequence and join to each other, such that one of the plurality of the first wrapping layers covers the outer surface of the first conductor, and the rest of the plurality of the first wrapping layers sequentially cover an outer surface of a former layer of the plurality of the first wrapping layers.

Preferably, the first wrapping layer includes an insulation material.

Preferably, the insulation material includes polytetrafluoroethene.

In one embodiment, the outer layer includes a second wrapping layer, the second wrapping layer continuously wraps around the outer surface of the inner layer along the circumferential direction and the length direction of the first conductor.

In one embodiment, the outer layer includes a plurality of the second wrapping layers, one of the plurality of the second wrapping layers continuously wraps around the outer surface of the inner layer along the circumferential direction and the length direction of the first conductor, and the rest of the plurality of the second wrapping layers continuously wrap around an outer surface of a former layer of the plurality of the second wrapping layers along the circumferential direction and the length direction of the first conductor.

Preferably, the second wrapping layer includes an insulation material.

Preferably, the insulation material includes polytetrafluoroethene.

According to the present invention, as the inner layer of the cable covers the outer layer of the first conductor, the puckering of the inner layer may be prevented, such that the inner layer may evenly cover the outer surface of the first conductor, in order to enhance the adhesion and encapsulation.

According to the present invention, as the outer layer of the cable continuously wraps around the outer surface of the inner layer, the overall structural strength of the cable may be enhanced, and the issues such as the deformation of the inner layer and the outer layer and the eccentricity of the first conductor may be prevented at the same time, such that the roundness and the concentricity and of the cable may be enhanced.

Besides, compared to the cable being made by the conventional winding method, the cable according to the present invention shows superior electrical characteristics (such as differential impedance, insertion loss, and skew) and mechanical properties (such as roundness, puckering, and pliability/flexibility).

### BRIEF DESCRIPTION OF THE DRAWINGS

FIG. 1 illustrates a cross-sectional view of a cable made by a conventional manufacturing method.

FIG. 2 illustrates a flow chart of a method of manufacturing a cable according to the present invention.

FIG. 3 illustrates a schematic view of Step S1 of the method of manufacturing the cable according to a first embodiment of the present invention.

FIG. 4 illustrates a schematic view of Step S2 of the method of manufacturing the cable according to the first embodiment of the present invention.

FIG. 5 illustrates a traverse cross-sectional view of the cable according to the first embodiment of the present invention.

FIG. 6 illustrates a longitudinal cross-sectional view of the cable according to the first embodiment of the present invention.

FIG. 7 illustrates a flow chart of a method of manufacturing a cable assembly according to the present invention.

FIG. 8 illustrates a traverse cross-sectional view of the cable assembly according to the first embodiment of the present invention.

FIG. 9 and FIG. 10 are schematic views of Step S1 of the method of manufacturing the cable according to a second embodiment of the present invention.

FIG. 11 and FIG. 12 are schematic views of Step S2 of the method of manufacturing the cable according to the second embodiment of the present invention.

FIG. 13 illustrates a traverse cross-sectional view the cable according to the second embodiment of the present invention.

FIG. 14 illustrates a longitudinal cross-sectional view of the cable according to the second embodiment of the present invention.

FIG. 15 illustrates a traverse cross-sectional view of the cable assembly according to the second embodiment of the present invention.

FIG. 16 is a picture showing a conventional cable.

FIG. 17 is a picture showing the deformation of an insulating layer of the conventional cable.

FIG. 18 is a metallographic diagram of showing a structure of the cable according to the present invention.

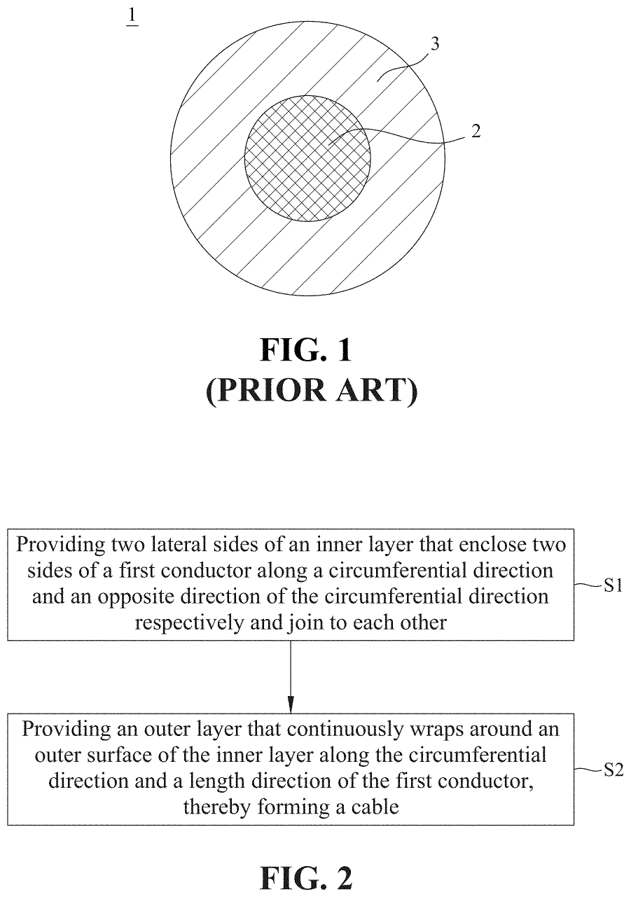

### DETAILED DESCRIPTION OF THE PREFERRED EMBODIMENT

The embodiments of the present invention are described more fully hereinafter with reference to the accompanying drawings, which form a part hereof, and which show, by way of illustration, specific exemplary embodiments by which the present invention may be practiced. These embodiments are provided so that the disclosure will be thorough and complete, and will fully convey the scope of the present invention to those skilled in the art.

Referring to FIG. 2 to FIG. 6, which are respectively the flow chart of a method of manufacturing a cable, schematic views of step S1 and step S2 of the method of manufacturing the cable according to a first embodiment of the present invention, and traverse and longitudinal cross-sectional views of a cable 41 according to the first embodiment of the present invention. The method of manufacturing the cable according to the present invention includes the steps of: step S1, providing two lateral sides 211, 212 of an inner layer 20 that enclose two sides of a first conductor 10 along a circumferential direction and an opposite direction of the circumferential direction respectively and join to each other, such that the inner layer 20 covers an outer surface of the first conductor 10; and step S2, providing an outer layer 30 that continuously wraps around an outer surface of the inner layer 20 along the circumferential direction and a length direction of the first conductor 10, thereby forming the cable 41.

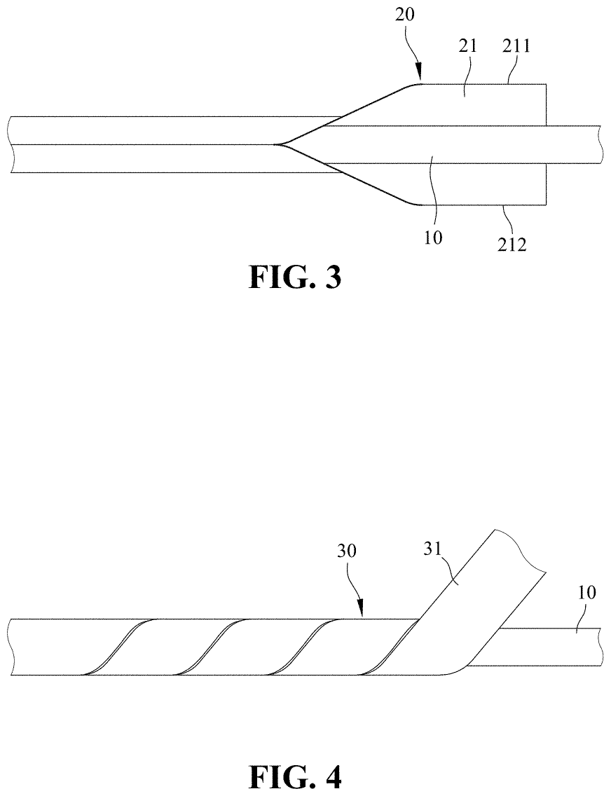

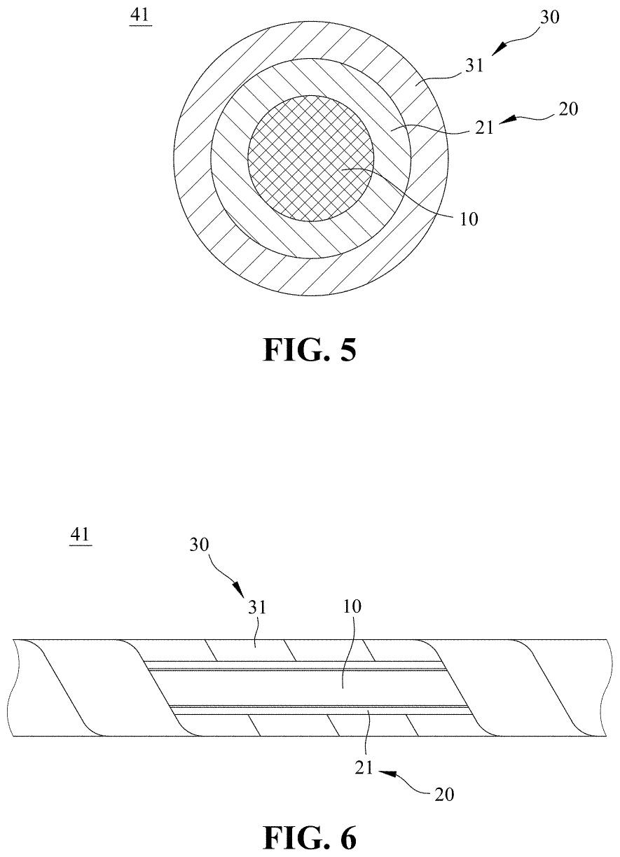

Furthermore, as shown in FIG. 2 and FIG. 3, in step S1 of the first embodiment, the inner layer 20 includes a first wrapping layer 21, two lateral sides 211, 212 of the first wrapping layer 21 enclose two sides of the first conductor 10 along the circumferential direction and the opposite direction of the circumferential direction respectively and join to each other, such that the first wrapping layer 21 covers the outer surface of the first conductor 10. As shown in FIG. 2 and FIG. 4, in step S2 of the first embodiment, the outer layer 30 includes a second wrapping layer 31, the second wrapping layer 31 continuously wraps around the outer surface of the inner layer 20 along the circumferential direction and the length direction of the first conductor 10, in order to form the cable 41 (referring to FIG. 5 and FIG. 6). Preferably, the materials of the first wrapping layer 21 and the second wrapping layer 22 include an insulation material for the purpose of insulation, wherein the insulation material includes polytetrafluoroethene.

As shown in FIG. 5 and FIG. 6, the cable 41 is provided according to the present invention, which includes the first conductor 10, the inner layer 20 and the outer layer 30. The structures and the relationships of the first conductor 10, the inner layer 20 and the outer layer 30 are described above.

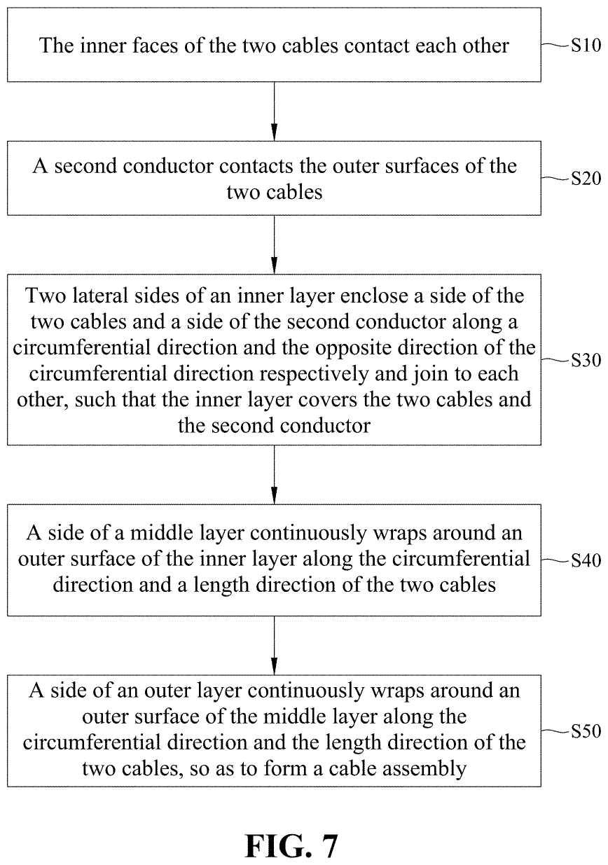

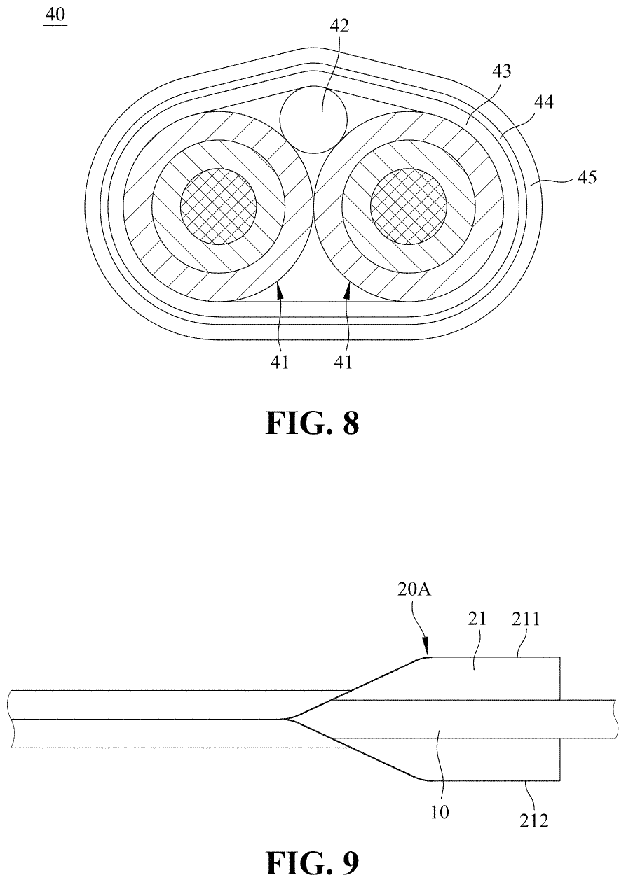

Referring to FIG. 7 and FIG. 8, FIG. 7 is a flow chart of a method of manufacturing a cable assembly according to the present invention. FIG. 8 is a traverse cross-sectional view of the cable assembly of according to a first embodiment of the present invention. The present invention provides a method of manufacturing a cable assembly, which includes the following steps:

Step S10: The inner sides of two cables 41 contact each other.

Step S20: A second conductor 42 contacts the outer surfaces of the two cables 41.

Step S30: Two lateral sides of an inner layer 43 enclose a side of the two cables 41 and a side of the second conductor 42 along another circumferential direction and the opposite direction of the other circumferential direction respectively and join to each other, such that the inner layer 43 covers the two cables 41 and the second conductor 42.

Step S40: A side of a middle layer 44 continuously wraps around an outer surface of the inner layer 43 along the other circumferential direction and a length direction of the two cables 41.

Step S50: A side of an outer layer 45 continuously wraps around an outer surface of the middle layer 44 along the other circumferential direction and the length direction of the two cables 41, so as to form a cable assembly 40.

As shown in FIG. 8, the present invention provides a cable assembly 40 which includes the two cables 41, the second conductor 42, the inner layer 43, the middle layer 44 and the outer layer 45, the structures and the relationships of the two cables 41, the second conductor 42, the inner layer 43, the middle layer 44 and the outer layer 45 are described above. Preferably, the materials of the inner layer 43 and the middle layer 44 may include Aluminum Mylar (Al-Mylar), and the material of the outer layer 45 may include hot melt polyethylene terephthalate Mylar (Hot-melt-PET Mylar).

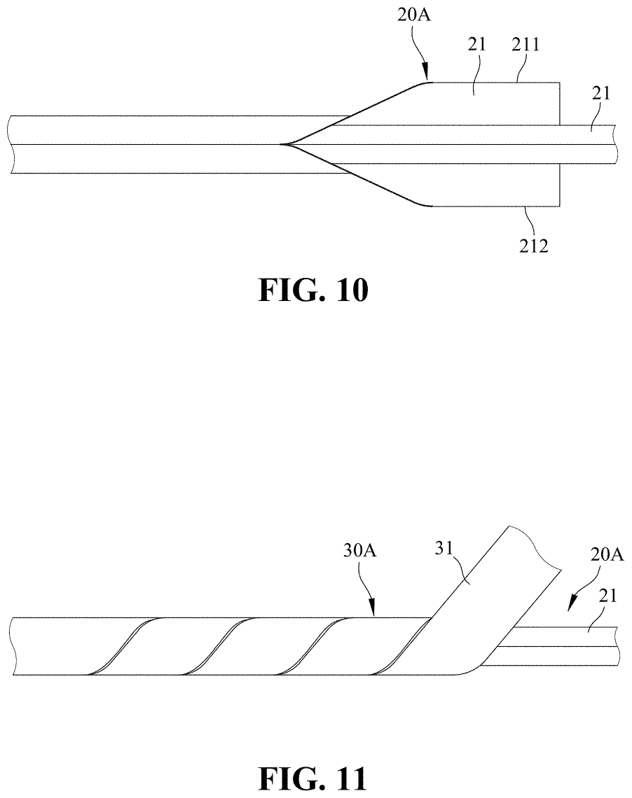

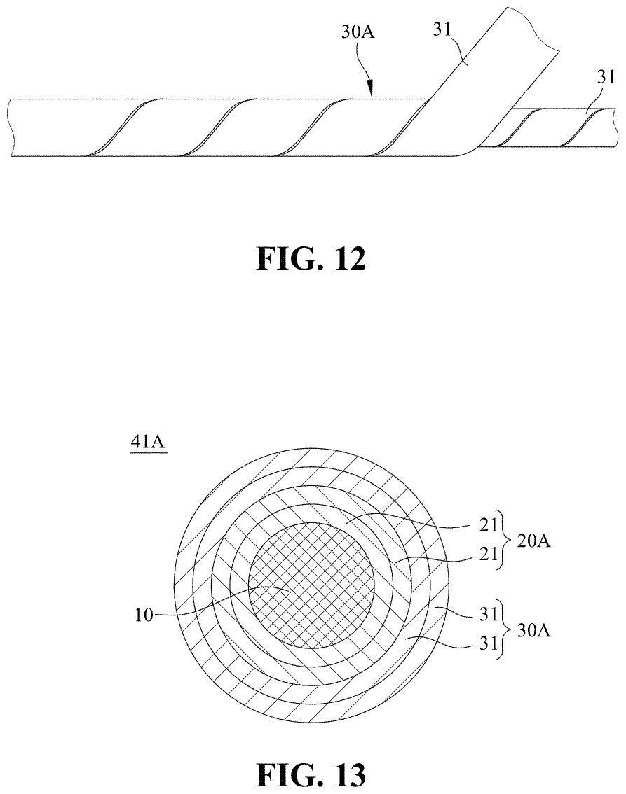

Referring to FIG. 2 and FIGS. 9 to 14, which are respectively a flow chart of a method of manufacturing a cable, schematic views of step S1 and step S2 according to a second embodiment, and traverse and longitudinal cross-sectional views of a cable 41A according to the second embodiment of the present invention. As shown in FIG. 2, FIG. 9 and FIG. 10, in step S1 of the second embodiment, an inner layer 20A includes a plurality of the first wrapping layers 21, two lateral sides 211, 212 of the plurality of the first wrapping layers 21 enclose the two sides of the first conductor 10 along the circumferential direction and the opposite direction of the circumferential direction respectively in sequence and join to each other, such that one of the plurality of the first wrapping layers 21 covers the outer surface of the first conductor 10, and the rest of the plurality of the first wrapping layers 21 sequentially cover an outer surface of a former layer of the plurality of the first wrapping layers 21. As shown in FIG. 2, FIG. 11 and FIG. 12, in the step S2 of the second embodiment, the outer layer 30A includes a plurality of the second wrapping layers 31, one of the plurality of the second wrapping layers 31 continuously wraps around the outer surface of the inner layer along the circumferential direction and the length direction of the first conductor 10, and the rest of the plurality of the second wrapping layers 31 continuously wrap around an outer surface of a former layer of the plurality of the second wrapping layers 31 along the circumferential direction and the length direction of the first conductor 10. Preferably, the materials of the first wrapping layer 21 and the second wrapping layer 31 include an insulation material for the purpose of insulation, wherein the insulation material includes polytetrafluoroethene.

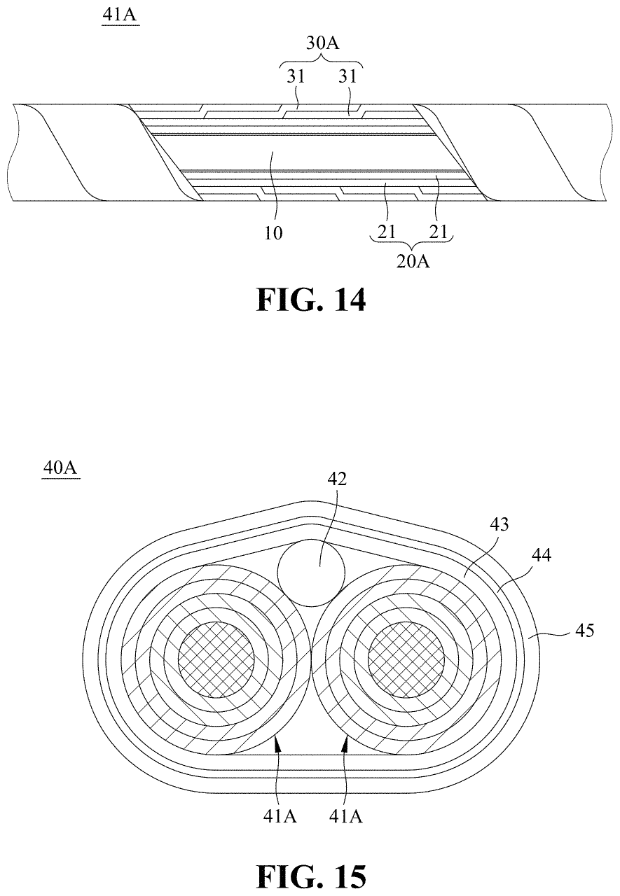

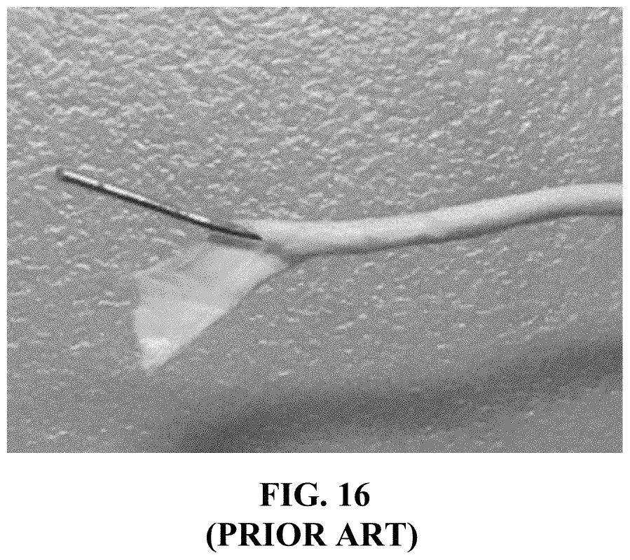

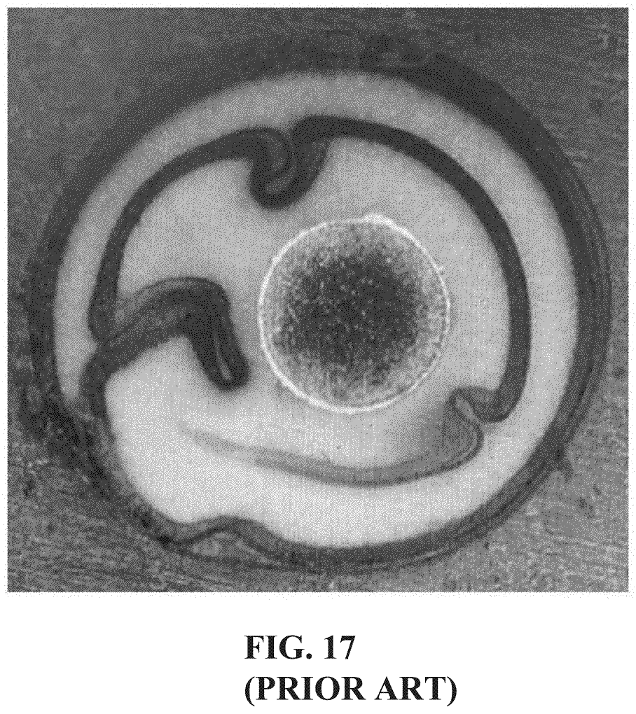

As shown in FIG. 13 and FIG. 14, according to the present invention, a cable 41A includes the first conductor 10, the inner layer 20A and the outer layer 30A, the structures and the relationships of the first conductor 10, the inner layer 20A and the outer layer 30A are described above.

Referring to FIG. 7 and FIG. 15, FIG. 7 is the flow chart of the method of manufacturing the cable assembly according to the present invention, and FIG. 15 is a traverse cross-sectional view of a cable assembly 40A according to the second embodiment of the present invention. The difference in the manufacturing method of the cable assembly between the first embodiment and the second embodiment is in using the cable 41A. The difference in the structure of the cable assembly between the first embodiment and the second embodiment is that the structure of the cable 41A is different from the structure of the cable 41. Apart from this, other technical characteristics are the same as that of the first embodiment.

Further examinations regarding various electrical characteristics and mechanical properties for the cables 41 and 41A in the present invention and the cable that is made by a conventional winding method are conducted. The examinations of electrical characteristics include differential impedance, insertion loss (at 13.28 G/Hz) and skew, in which the target value of the differential impedance is preset at 105±5Ω. The examinations of mechanical properties include roundness, puckering and pliability/flexibility, in which the testing condition for the pliability/flexibility includes (1) a bend radius at 10×R (2) a bend angle at 180°±90° (3) a bend speed at 13 cycles/min, and (4) a load capacity of 50 g. The results of the examinations are organized in the table below:

| | |
|---|---|
| the cable made by | the cables 41 and |
| a conventional | 41A in the present |
| winding method | invention |

| | | | | |
|---|---|---|---|---|
| Differential impedance | 99-119 | Ω | 102-109 | Ω |
| Insertion loss | ≤−3.40 | dB/m | ≤−2.70 | dB/m |
| Skew | ≤16 | ps/M | ≤10 | ps/M |
| Pliability/Flexibility | 60 | cycles | 500 | cycles |

| | | |
|---|---|---|
| Roundness | 80-85% | >93% |
| Puckering | Yes | No |

According to the table above, the cables 41 and 41A in the present invention have the following advantages over the cable made by the conventional winding method: firstly, the roundness of the cables 41 and 41A in the present invention is apparently higher and closer to a round shape; secondly, the differential impedance of the cables 41 and 41A in the present invention is closer to the target value of the differential impedance at 105Ω which is more stable; thirdly, the insertion loss of the cables 41 and 41A in the present invention is lower, and the authenticity and the completeness of the obtained transmission signal are improved; fourthly, the skew of the cables 41 and 41A in the present invention is smaller, therefore lower chance of misinterpretations and lower error rate; fifthly, the pliability/flexibility of the cables 41 and 41A in the present invention is better, and the service life is longer; and lastly, there is no puckering of the cables 41 and 41A in the present invention, which enhances the adhesion and encapsulation between the inner layers 20, 20A and the first conductor 10.

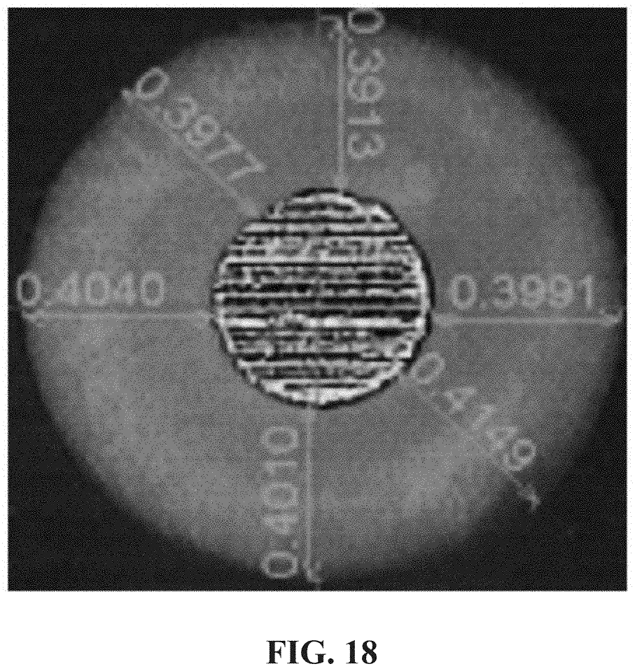

In summary, according to the present invention, the inner layers 20, 20A of the cables 41, 41A cover the outer surface of the first conductor 10, in this way, the puckering of the inner layers 20, 20A can be prevented, such that the inner layers 20, 20A cover the outer surface of the first conductor 10 evenly, enhancing the adhesion and encapsulation of the inner layers 20A, 20A and the first conductor 10. The results can be observed from the metallographic diagram in FIG. 18.

Moreover, according to the present invention, the outer layers 30, 30A of the cables 41, 41A continuously wrap around the outer surfaces of the inner layers 20, 20A, in this way, the overall structural strength of the cables 41, 41A can be enhanced, and the issues such as the deformations of the inner layers 20, 20A and the outer layers 30, 30A and the eccentricity of the first conductor 10 can be tackled at the same time, such that the roundness and the concentricity of the cables 41, 41A are enhanced. The results can be observed from the metallographic diagram in FIG. 18.

Besides, compare to the cable being made by the conventional winding method, the cable according to the present invention shows superior electrical characteristics (such as differential impedance, insertion loss, and skew) and mechanical properties (such as roundness, puckering, and pliability/flexibility).

It is worth noting that, in the present invention, the cable assembly that is made of the cables 41, 41A has all the advantages of the cables 41, 41A.

While various embodiments have been described above, it should be understood that they have been presented by way of example only, and not limitation. Any modifications, equivalent substitutions, improvements, etc., made within the spirit and scope of the disclosure are intended to be included within the scope of the disclosure.

What is claimed is:

1. A method of manufacturing a cable, comprising the following steps of:
(a) providing two lateral sides of an inner layer that enclose two sides of a first conductor along a circumferential direction and an opposite direction of the circumferential direction respectively and join to each other, such that the inner layer covers an outer surface of the first conductor; and
(b) providing an outer layer that continuously wraps around an outer surface of the inner layer along the circumferential direction and a length direction of the first conductor, thereby forming the cable.

2. The method according to claim 1, wherein the inner layer includes a first wrapping layer, two lateral sides of the first wrapping layer enclose the two sides of the first conductor along the circumferential direction and the opposite direction of the circumferential direction respectively and join to each other, such that the first wrapping layer covers the outer surface of the first conductor.

3. The method according to claim 1, wherein the inner layer includes a plurality of the first wrapping layers, two lateral sides of the plurality of the first wrapping layers enclose the two sides of the first conductor along the circumferential direction and the opposite direction of the circumferential direction respectively in sequence and join to each other, such that one of the plurality of the first wrapping layers covers the outer surface of the first conductor, and the rest of the plurality of the first wrapping layers sequentially cover an outer surface of a former layer of the plurality of the first wrapping layers.

4. The method according to claim 2, wherein the first wrapping layer includes an insulation material.

5. The method according to claim 4, wherein the insulation material includes polytetrafluoroethene.

6. The method according to claim 1, wherein the outer layer includes a second wrapping layer, the second wrapping layer continuously wraps around the outer surface of the inner layer along the circumferential direction and the length direction of the first conductor.

7. The method according to claim 1, wherein the outer layer includes a plurality of the second wrapping layers, one of the plurality of the second wrapping layers continuously wraps around the outer surface of the inner layer along the circumferential direction and the length direction of the first conductor, and the rest of the plurality of the second wrapping layers continuously wrap around an outer surface of a former layer of the plurality of the second wrapping layers along the circumferential direction and the length direction of the first conductor.

8. The method according to claim 6, wherein the second wrapping layer includes an insulation material.

9. The method according to claim 8, wherein the insulation material includes polytetrafluoroethene.

10. A cable, comprising:
a first conductor;
an inner layer, wherein two lateral sides of the inner layer enclose two sides of the first conductor along a circumferential direction and an opposite direction of the circumferential direction respectively and join to each other, such that the inner layer covers an outer layer of the first conductor; and
an outer layer continuously wrapping around an outer surface of the inner layer along the circumferential direction and a length direction of the first conductor.

11. The cable according to claim 10, wherein the inner layer includes a first wrapping layer, two lateral sides of the first wrapping layer enclose the two sides of the first conductor along the circumferential direction and the opposite direction of the circumferential direction respectively and join to each other, such that the first wrapping layer covers the outer surface of the first conductor.

12. The cable according to claim 10, wherein the inner layer includes a plurality of the first wrapping layer, two lateral sides of the plurality of the first wrapping layers enclose the two sides of the first conductor along the circumferential direction and the opposite direction of the circumferential direction respectively in sequence and join to each other, such that one of the plurality of the first wrapping layers covers the outer surface of the first conductor, and the rest of the plurality of the first wrapping layers sequentially cover an outer surface of a former layer of the plurality of the first wrapping layers.

13. The cable according to claim 11, wherein a material of the first wrapping layer includes an insulation material.

14. The cable according to claim 13, wherein the insulation material includes polytetrafluoroethene.

15. The cable according to claim 10, wherein the outer layer includes a second wrapping layer, the second wrapping layer continuously wraps around the outer surface of the inner layer along the circumferential direction and the length direction of the first conductor.

16. The cable according to claim 10, wherein the outer layer includes a plurality of the second wrapping layers, one of the plurality of the second wrapping layers continuously wraps around the outer surface of the inner layer along the circumferential direction and the length direction of the first conductor, and the rest of the plurality of the second wrapping layers continuously wrap around an outer surface of a former layer of the plurality of the second wrapping layers along the circumferential direction and the length direction of the first conductor.

17. The cable according to claim 15, wherein a material of the second wrapping layer includes an insulation material.

18. The cable according to claim 17, wherein the insulation material includes polytetrafluoroethene.
